(19) United States
(12) Patent Application Publication
(10) Pub. No.: US 2006/0026567 A1
(43) Pub. Date: Feb. 2, 2006

(54) Distribution of data/metadata in a version control system

(76) Inventors: Lawrence W. McVoy, San Francisco, CA (US); Wayne H. Scott, Churubusco, IN (US); Richard B. Smith, Pittsburgh, PA (US)

Correspondence Address: Benjamin T. Queen, II;Pietragallo, Bosick & Gordon, One Oxford Centre, 38th Floor, 301 Grant Street, Pittsburgh, PA, 15219, US

(21) Appl. No.: 10/899,560

(22) Filed: Jul. 27, 2004

(51) Int. Cl. G06F 9/44

(52) U.S. Cl. 717/120; 717/122

(57) ABSTRACT

A version control system capable of distributing data/metadata is provided. The invention provides a version control system capable of replicating version control data on an as needed basis so as to more efficiently maintain and operate the version control system.

### FIELD OF THE INVENTION

The present invention relates generally to version control systems, and specifically to a version control system capable of distributing data/metadata.

### BACKGROUND INFORMATION

A group of software developers working together to create a product often runs into the problem of coordinating their work. Changes are made which overwrite other changes. Versions of the system which functioned well are overwritten with versions containing buggy new features. Bugs found in prior versions are hard to track down because the prior versions are no longer available. To aid in reducing the cost of having these problems, version control systems are used.

Referring to FIG. 1a, a typical version control system 120 is made up of one or more repositories 100 each of which is related to one or more file system workspaces 110. Workspaces are file system hierarchies made up of files, directories, and symbolic links. Users give requests 140 to the version control system to modify the files, directories, or symbolic links by the check-out operation. After modifications are done, the user does a check-in operation to store the modifications in the repository. At some time the user commits the change allowing others who have access to the repository 100 to make use of the new change in other workspaces. The repositories act like a vault storing work, which has been done. The workspaces are a place to view existing versions, develop new versions, and merge new versions with versions created by others.

The version control system enables the user to be able to go back in time to recover an earlier state of the workspace. This may be done because the current version has some problem and an earlier version did not. Or a problem was reported relating to an earlier version, and the user wants to understand the problem in the context of the earlier version.

The version control system also enables a user to gain understanding on how the current version evolved to its current state. This can be done by giving requests 140 to have the version control system 120 generate a variety of reports 150. These reports can be in graphical form showing the historical progression of versions in the system, or a textual report showing who made the changes to a particular version, when that user made the change and any comment entered at the time to document why the change was made. These reports are as valuable to the users of the system as being able to recover earlier versions of items controlled by the system.

The reports combine data (information under version control) and metadata (information about the information under version control). Examples of metadata include, but are not limited to, change author, change date, change revision, and computer host name on which the change was done. An example report might be to list all change revisions and the associated comments for work done by “Bob Jones” between May 5, 2000 and Jun. 12, 2001. Examples of a combination report is an annotated file listing which lists each line in the file prepended by a selection of metadata, such as author and revision of that line.

Advanced version control can replicate repositories facilitating development. This is shown, for example, in FIG. 1b, with the initial repository A 160 replicated in B 170. Each repository now functions in a separate independent version control system described in FIG. 1a. The repositories can be in the same computer or be in different computers that are connected by a network 179.

Typically in version control systems, numerous versions of the files being worked on by various users are checked in and subsequently all of the version control data relating to the versions is replicated to each repository. This can result in storage space problems. In addition, this can result in large files being replicated to repositories where the version control data is not needed, or else not all of the version control data is needed at the time it is replicated. What is lacking, therefore, in a typical version control system is the ability to control or more efficiently manage the replication of version control data to repositories of the version control system.

There is identified, therefore, a need for an improved version control system that overcomes disadvantages, limitations and/or shortcomings of known version control systems.

### SUMMARY OF THE INVENTION

An aspect of the present invention is to provide on a computer system capable of implementing version control, a method comprising providing a first repository with version control data corresponding to a version, providing a second repository, and replicating a portion of the version control data from the first repository to the second repository. The version control data may include data and metadata and the method may further comprise separating the data and the metadata. In addition, the invention may include the portion of the version control data replicated to the second repository being the metadata or the data.

Another aspect of the present invention is to provide a computer system capable of implementing version control comprising a processor and a memory in communication with the processor, the memory having stored thereon a set of data and instructions including a version control system which, when executed by the processor, caused the processor to perform the steps of providing a first repository with version control data corresponding to a version, providing a second repository, and replicating a portion of the version control data from the first repository to the second repository.

A further aspect of the present invention is to provide an apparatus for implementing version control, comprising means for providing a first repository with version control data corresponding to a version, means for providing a second repository, and means for replicating a portion of the version control data from the first repository to the second repository.

An additional aspect of the present invention is to provide a computer readable medium having stored thereon instructions which when executed by a processor caused the processor to perform the steps of providing a first repository with version control data corresponding to a version, providing a second repository, and replicating a portion of the version control data from the first repository to the second repository.

These and other aspects of the present invention will be more apparent from the following description.

### BRIEF DESCRIPTION OF THE DRAWINGS

FIGS. 1a-1b are diagrams showing components of a typical version control system.

FIG. 2 shows an embodiment of the invention in a computer network

FIG. 3 shows the structure of a repository for use with an embodiment of the invention.

FIGS. 4a-4b show metadata in the file and file-version in accordance with the invention.

FIG. 5 shows a clone operation replicating a portion of the binary versions in accordance with the invention.

FIG. 6 shows a pull operation replicating a portion of the binary versions in accordance with the invention.

FIGS. 7a-7c show a check out operation replicating binary versions in accordance with the invention.

FIG. 8 shows a first repository interacting with a second repository in accordance with the invention.

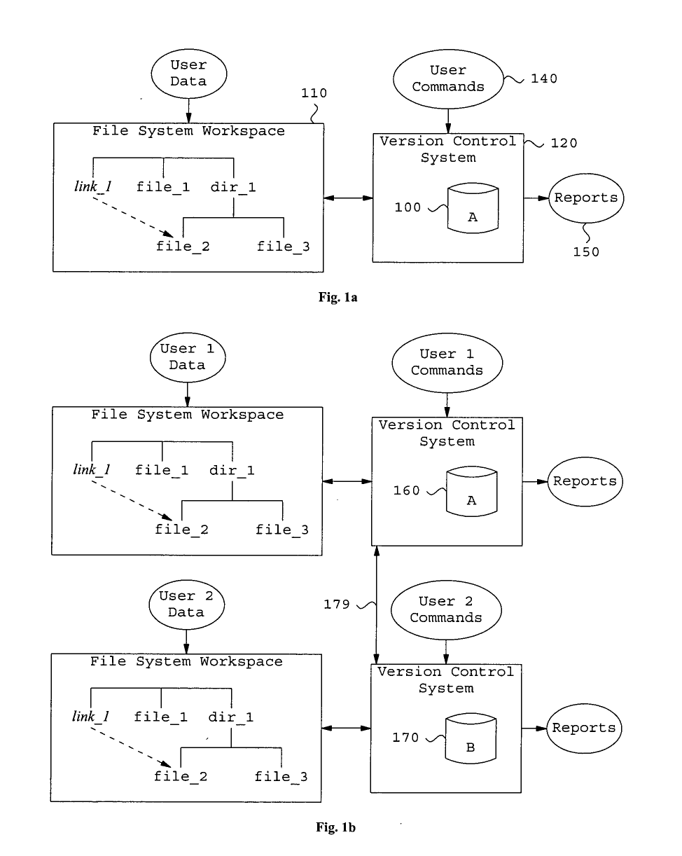

### DETAILED DESCRIPTION

Version control systems typically are used to manage files, directories, and symbolic links to files and directories. Some advanced version control systems support replicating the version control data allowing developers to work distributed. The present invention provides an improved version control system capable of replicating version control data on an as needed basis.

Referring to the figures appended hereto, embodiments of the invention will be described in detail herein. It is to be understood that the figures and descriptions set forth herein of the present invention have been simplified to illustrate elements that are relevant for a clear understanding of the present invention, while eliminating, for purposes of clarity, other elements that may be typically found in a version control system and/or a computer or computer network capable of implementing a version control system. For example, specific operating system details and modules are not shown. Also, specific network items, such as network routers, are not shown. Those of ordinary skill in the art will recognize that other elements may be desirable to produce an operational system incorporating the present invention. However, because such elements are well known in the art, and because they do not facilitate a better understanding of the present invention, a discussion of such elements is not provided herein.

As used herein, the term “repository” generally refers to a collection of objects, typically files, directories, and/or symbolic links, maintained by a version control system. The term “baseline” generally refers to the initial state of the collection of objects contained within a particular repository. The term “change” generally refers to a record of alterations done to objects contained in a repository, usually stored in an efficient way and can be applied to a baseline to result in a new version.

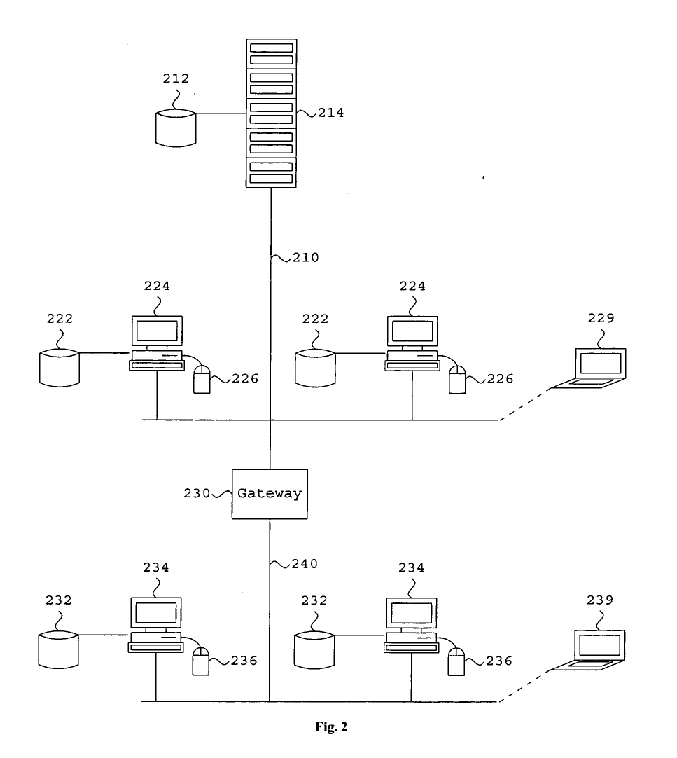

FIG. 2 shows an example of an apparatus for performing the present invention. The apparatus includes a local area network (LAN) 210 with a server 214 and disk array 212, as well as a collection of workstations, each including a monitor and keyboard 224, disk storage 222 and a mouse 226. The LAN may be connected through a gateway 230 to other networks, such as the LAN 240 shown with a collection of workstations, each with a monitor and keyboard 234, disk storage 232 and a mouse 236. Laptop computers 229 may be connected to the LAN network 210 at times either with wire or wireless. Laptop computers 239 may also be connected to other LANs 240 in a similar manner. The same laptop at different times might be connected to either network, or operated not connected to any network. It will be appreciated that in accordance with the invention the repositories, as described herein, may reside on one or more computers and/or may be located in different locations.

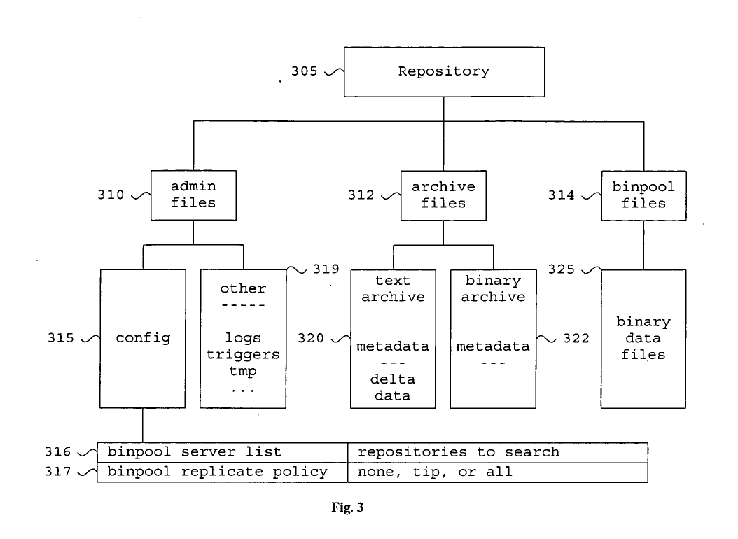

FIG. 3 shows an example structure of a version control repository for use with the present invention. The whole repository 305 is composed of admin files 310, version archive files 312, and binpool files 314. Admin files can hold configuration data 315, logs, triggers, temporary files, or other 319. Configuration files can contain configuration for binpool operation. The ‘binpool server list’ 316 holds a list of servers, and is a non-version controlled file that is replicated to other repositories only during the clone operation. The ‘binpool replicate policy’ 317 is used for setting default policy on binary file replication. It can be set to all, tip, or none. All means to replicate all versions of the file. Tip means just replicate the current version. None means to not replicate any. The policy setting is version controlled and replicates to other repositories in the same manner as other version controlled files.

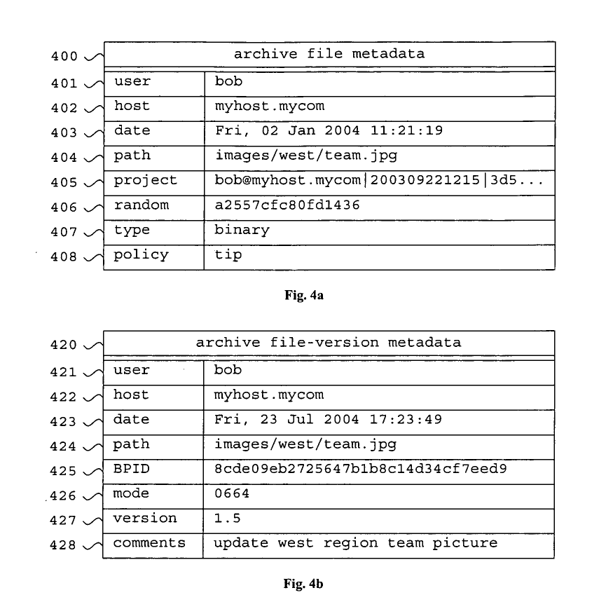

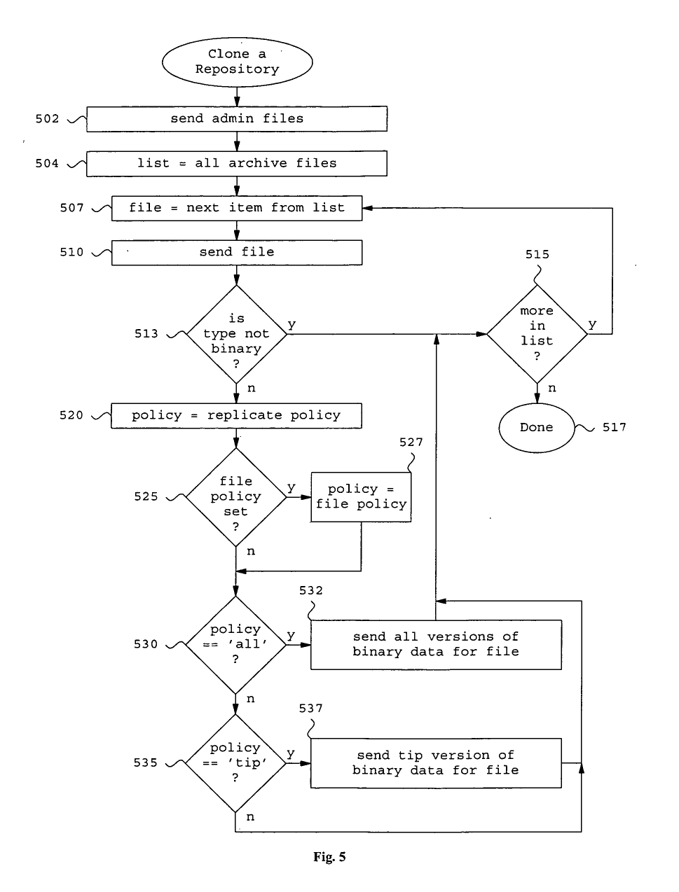

Version archive files 312 can be for text 320, or binary 322 data. Text archive files can store all versions efficiently using know method of delta storage. Examples are Revision Control System (RCS) and Source Code Control System (SCCS). Binary archive files hold only metadata (FIG. 4), including a pointer to binary data stored in the binpool 314. It will be understood that the invention is applicable to text files, other types of files, as well as binary files as described herein.

Binpool files 314 are the binary data files 325 corresponding to versions of binary files 322. Each binary data file can be referenced using a unique binpool identification (BPID), which is stored in the binary archive file metadata (FIG. 4).

FIG. 4a shows some of the metadata that may be associated with a file 400. Listed are the user who created the file 401, the host computer on which it was created 402, the creation date 403, the file path when it was created 404, a string representing the project in which this file is a member 405, a random number 406 which is used to help identify this file uniquely, and the type of file it is 407: text or binary. If the type is binary, then the replicate policy for this file can be recorded. States are ‘none’, ‘tip’, ‘all’, or ‘use system default’.

FIG. 4b shows some of the metadata that may be associated with a particular version of a file (also called file-version) 420. Listed are the user who modified the file 421, the host computer on which it was modified 422, the modification date 423, the file path after it was modified 424, the BPID of the file-version 425, the mode, also known as permissions, of the version 426, the version number 427 and any comments entered by at the time the modification was checked in 428.

FIG. 5 shows the clone operation with partial replication of the binary file-versions. The clone operation creates a replica of an existing repository. This diagram shows the clone operation from the point of view of the existing repository sending data to the new clone. It starts by sending the admin files 502, then creating a list of all archive files 504. It then goes through this list one at a time 507, sending the file 510, and checking if the file is other than binary 513. If yes, then the operation checks if there are more files 515, and if not, it is done 517. Otherwise it does the next file 507. When the file is binary, the test in 513 is answered no. The replicate policy 520 is set to the configuration setting 317, which can be ‘none’, ‘tip’ or ‘all’. The metadata in the file is searched to check if an overriding replicate policy 408 is set 525, and if yes, that policy is used 527. If the policy is ‘all’ 530, then send all file-versions corresponding to this file 532. If the policy is ‘tip’ 535, then send only the most recent version 537. If the policy is set to ‘none’, then do not send any binary file-versions, but instead, just loop back to test 515 to check if there are more files to process.

Using the tip policy, a replicated repository can be significantly smaller because it does not contain earlier versions of binary data. Yet the user of the system will be able to operate on the latest version, so almost no useful functionality is lost.

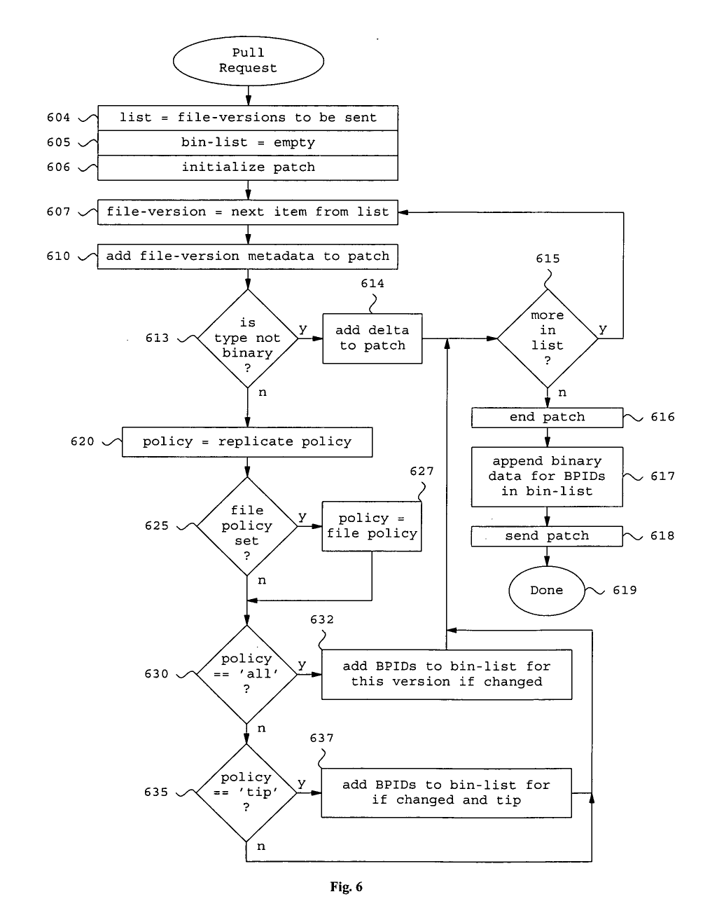

FIG. 6 shows the pull operation with partial replication of the binary file-versions. The pull operation updates a local repository with a patch containing changes done in other repositories. This diagram shows the pull operation from the point of view of the remote repository sending patch data to the local repository. It starts by creating a list of all file-versions to be sent 604. It then initializes a list of binary version BPIDs, called bin-list, to have nothing in it 605. And it initializes the patch in the normal way 606. The loop starts by reading each file-version from the list one at a time 607. Each file-version will have associated metadata, (FIG. 3c), and that gets put into the patch 610. Next, the type of the file is checked 613, and if not binary, the version delta is added to the patch 614, then check for more files to process 615. If none, loop back and get next file-version 607, else finish up, which will be described herein.

When the file is binary, the test in 613 is answered no. The replicate policy 620 is set to the configuration setting 317, which can be ‘none’, ‘tip’ or ‘all’. The metadata in the file is searched to check if an overriding replicate policy 408 is set for this file 626, and if yes, that policy is used 627. If the policy is ‘all’ 630, then add to the bin-list the BPID for the binary data in the binpool if this version modified the data. If the policy is ‘tip’ 635, then only add the BPID if the version is also the current version.

When all file-versions have been processed, then mark the end of the patch 616, then append to the patch all of the binary files corresponding to the BPIDs in bin-list. The patch is now ready to be sent to the requesting repository 618, and integrated in using normal methods.

The mirror operation of a pull is a push, which sends work done locally to another repository. In an embodiment of the invention, this function does not support replicating a portion, but will always replicate all. This is because the stability and robustness: that distributing copies of the data is desirable.

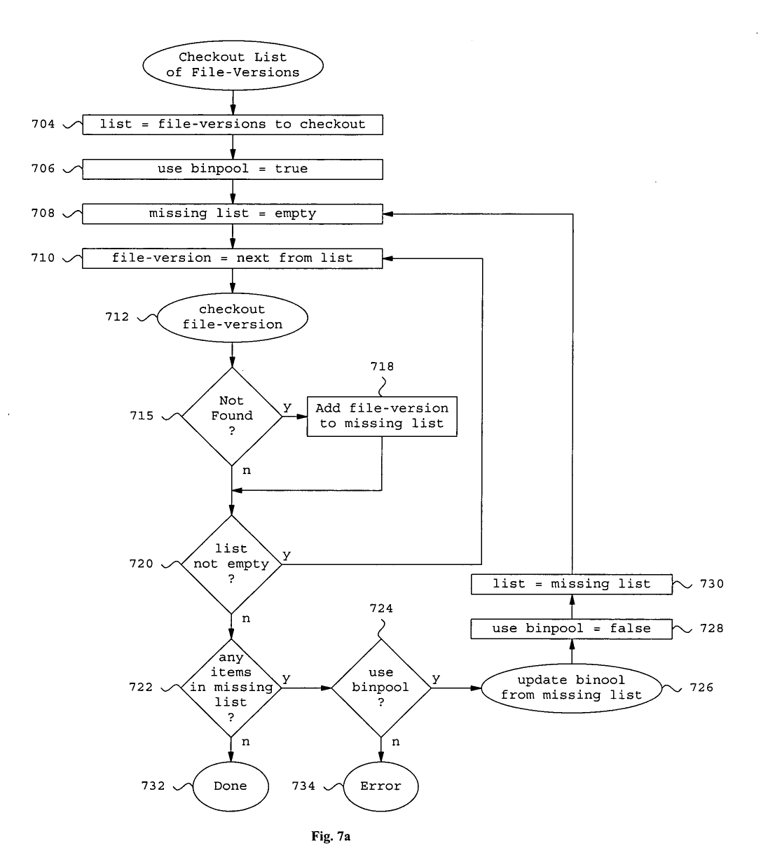

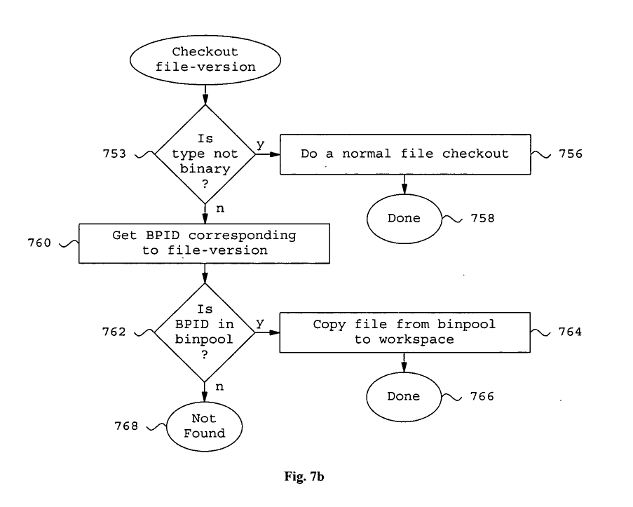

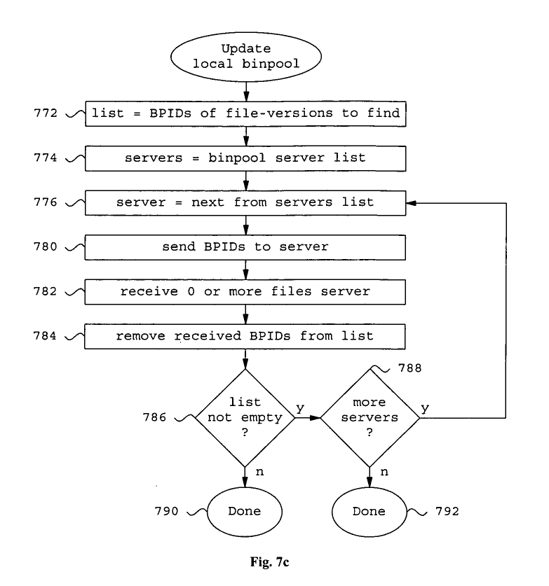

FIG. 7a shows the file checkout operation. It operates on a list of desired file-versions to check out 704. The first pass through the routine, it will check remote binpool servers 706 to check for missing files, which is initialized to none 708. For each file-version in the list 710, try to check it out from the local repository 712 (also FIG. 7b). If it is not found in the local repository 715, then add it to the list of missing 718. In either case, if there are more files, loop back to process the next one 720. When all files have been processed, check if any are missing 722, and if no, then the operation is complete.

If there are missing files, then check if it is valid to check remote binpools 724. The case where it is not will be covered later. The case where it can will cause the local binpool to be updated by remote binpools 726 (also FIG. 7c). When that completes, set the ‘use binpool’ flag to false 728 to prevent an infinite loop searching remote binpool servers. Reset the list of files being checked out to the list of files that were missing 730, and loop back to clearing the missing list 708 and checking out the file 712.

When the loop finishes this time, it will check for any items in the missing list 722. If they aren't, then the function will end with operation completed. If there are files in the missing list, the ‘use binpool’ flag will be checked 724 and found to be false because of 728. This will cause the operation to end with an error 734.

In case of an error, the user will need to either add binary data to the binpool servers, or use a binpool server that has the data.

FIG. 7b shows the checkout operation for a file-version. If the file is not binary 753, then a normal checkout can be done 756 and the operation completed 758. If it is binary, then the BPID is computed 760, and the local binpool checked files corresponding to the BPID 762. If found, then the data is copied from the binpool to the workspace 764 and the function completes 766. If the BPID does not match any files in the binpool, then the operation completes with file-version not found 768.

FIG. 7c shows the operation of updating a local binpool from remote binpool servers, starting with computing the BPIDs for a list of file-versions 772. A server list is initialized 774 from the binpool server list 316, and the operation cycles through them one at a time 776. For each server, it sends the list of BPIDs 780, and gets back zero (0) or more files to be placed in the local binpool 782. The BPIDs of the received files are removed from the list 784 and the list checked for more 786. If it is empty, the operation is complete 790. Otherwise, if there are no more servers 788, then the operation is completed 792. It is not an error to not find all the files. This functions job is to find as many as it can. If there are more servers, then the operation loops back to 776 to continue searching.

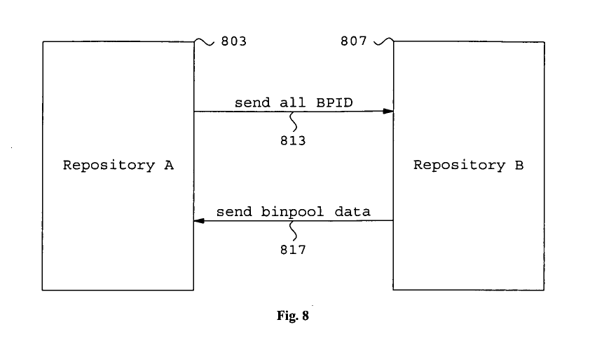

FIG. 8 shows repository A 803 requesting an update from repository B 807 by sending all repository A's BFID 813 to repository B, and repository responding by sending binpool data files that B has and A does not. This means A could have binpool data without having the corresponding metadata. This may be used to have repository A act as a binpool server only with no archive files.

Whereas particular embodiments of this invention have been described above for purposes of illustration, it will be evident to those skilled in the art that numerous variations of the details of the present invention may be made without departing from the invention as defined in the appended claims.

What is claimed is:

1. On a computer system capable of implementing version control, a method comprising:
providing a first repository with version control data corresponding to a version;
providing a second repository; and
replicating a portion of the version control data from the first repository to the second repository.

2. The method of claim 1, wherein the version control data includes data and metadata.

3. The method of claim 2, wherein the portion of the version control data replicated to the second repository is the metadata.

4. The method of claim 2, wherein the portion of the version control data replicated to the second repository is the data.

5. The method of claim 1, further comprising providing the first repository on a first version control system.

6. The method of claim 2, further comprising providing the second repository on a second version control system.

7. The method of claim 1, further comprising subsequently replicating an additional portion of the version control data from the first repository to the second repository.

8. An apparatus for implementing version control, comprising:
means for providing a first repository with version control data corresponding to a version;
means for providing a second repository; and
means for replicating a portion of the version control data from the first repository to the second repository.

9. The apparatus of claim 8, wherein the version control data includes data and metadata.

10. The apparatus of claim 9, wherein the portion of the version control data replicated to the second repository is the metadata.

11. The apparatus of claim 9, wherein the portion of the version control data replicated to the second repository is the data.

12. The apparatus of claim 9, further comprising means for providing the first repository on a first version control system.

13. The apparatus of claim 12, further comprising means for providing the second repository on a second version control system

14. The apparatus of claim 8, further comprising means for subsequently replicating an additional portion of the version control data from the first repository to the second repository.

15. A computer system capable of implementing version control, comprising:
a processor; and
a memory in communication with the processor, the memory having stored thereon a set of data and instructions including a version control system which, when executed by the processor, cause the processor to perform the steps of:
providing a first repository with version control data corresponding to a version;
providing a second repository; and
replicating a portion of the version control data from the first repository to the second repository.

16. The computer system of claim 15, wherein the portion of the version control data replicated to the second repository is metadata.

17. The computer system of claim 15, wherein the portion of the version control data replicated to the second repository is data.

18. The computer system of claim 15, further comprising subsequently replicating an additional portion of the version control data from the first repository to the second repository.

19. A computer readable medium having stored thereon instructions which, when executed by a processor, cause the processor to perform the steps:
providing a first repository with version control data corresponding to a version;
providing a second repository; and
replicating a portion of the version control data from the first repository to the second repository.

20. The computer readable medium of claim 19, wherein the version control data includes data and metadata.

21. The computer readable medium of claim 20, wherein the portion of the version control data replicated to the second repository is the metadata.

22. The computer readable medium of claim 20, wherein the portion of the version control data replicated to the second repository is the data.

23. The computer readable medium of claim 19, further comprising means for subsequently replicating an additional portion of the version control data from the first repository to the second repository.
